(19) United States
(12) Patent Application Publication
(10) Pub. No.: US 2005/0278503 A1
(43) Pub. Date: Dec. 15, 2005

(54) Coprocessor bus architecture

(76) Inventor: Niall D. McDonnell, Limerick (IE)

Correspondence Address: BUCKLEY, MASCHOFF, TALWALKAR LLC, 5 ELM STREET, NEW CANAAN, CT, 06840, US

(21) Appl. No.: 10/403,428

(22) Filed: Mar. 31, 2003

(51) Int. Cl. G06F 15/00

(52) U.S. Cl. 712/34

(57) ABSTRACT

According to some embodiments, a coprocessor bus architecture is provided.

### BACKGROUND

The operation of a core processor can be facilitated by a number of coprocessors. For example, FIG. 1 is a block diagram of a known system 100 including a central, or “core,” processor 110 and a number of coprocessors 120, 130. The core processor 110 might be, for example, a Reduced Instruction Set Computer (RISC) microprocessor associated with low-level data processing in the physical layer (PHY) of the Open Systems Interconnection (OSI) Reference Model as described in International Organization for Standardization (ISO)/International Electrotechnical Commission (IEC) document 7498-1 (1994). The coprocessors 120, 130 might, for example, provide a PHY interface to a data stream or hardware assistance for processing tasks. Although two coprocessors 120, 130 are illustrated, the system 100 might include more than two coprocessors.

The core processor 110 communicates with the coprocessors 120, 130 via a coprocessor bus. As illustrated in FIG. 1, the coprocessor bus includes one or more paths that the core processor 110 can use to transmit instructions and data (e.g., “data in”) to the coprocessors 120, 130. The coprocessor bus also includes one or more paths that the core processor 110 can use to receive data (e.g., “data out”) from the coprocessors 120, 130. A multiplexer 140 determines which of the data out paths are routed to the core processor 110. In addition, the core processor 110 can activate a SELECT signal for each of the coprocessors 120, 130. When a coprocessor detects an active SELECT signal, it executes the instruction that is present on the coprocessor bus.

The core processor 110 may use the coprocessor bus, for example: to request data from a coprocessor; to request to set a value in a coprocessor using the result of an instruction (e.g., by instructing the coprocessor to read data from memory—in which case the result is the value of the data that is read); or to request that a coprocessor perform an operation, such as to increment a value in the coprocessor (in which case, the data in and data out paths are not needed).

Typically, instructions in the system 100 are issued and performed during a single clock cycle. For example, FIG. 2 is a timing diagram that illustrates coprocessor bus signals. Consider the first clock cycle during which the core processor 110 will read data from coprocessor A. In this case, the core processor 110 issues a read instruction and activates the SELECT A signal. As a result, coprocessor A determines the appropriate value being requested by the core processor 110 and places the value on the data out paths of the coprocessor bus. Note that there may be a delay D between the beginning of the clock cycle and the time that the associated data is received by the core processor 110 (e.g., because the instruction propagates to coprocessor A, coprocessor A decodes the instruction and determines the appropriate data, and the data propagates back to the core processor 110).

Now consider the second clock cycle in FIG. 2, during which the core processor 110 will write data to coprocessor B. In this case, the core processor 110 issues a write instruction and activates the SELECT B signal. The core processor 110 also places the appropriate data on the data in paths of the coprocessor bus. As a result, coprocessor B uses the information on the data in paths as instructed by the core processor 110 (e.g., by writing that value into memory).

This typical approach, however, has a number of disadvantages. For example, the delay between the beginning of a clock cycle and the time that the associated data is received by the core processor 110 will restrict the speed of the coprocessor bus (e.g., because the clock cycle needs to be at least as long as this delay). Moreover, the timing restriction may be sensitive to the layout of the system 100. In addition, transferring data from one coprocessor to another may not be efficient (e.g., because the core processor 110 reads the data from one coprocessor during one clock cycle, turns the data around, and writes the data to the other coprocessor during a subsequent clock cycle). Although a dedicated interconnect could be used between two coprocessor to facilitate this type of transfer, such an approach might limit the reusability of the coprocessor (e.g., because an extra data port may be added whenever a new dedicated interconnect is required).

### BRIEF DESCRIPTION OF THE DRAWINGS

FIG. 1 is a block diagram of a known system including a core processor and a number of coprocessors.

FIG. 2 is a timing diagram that illustrates coprocessor bus signals.

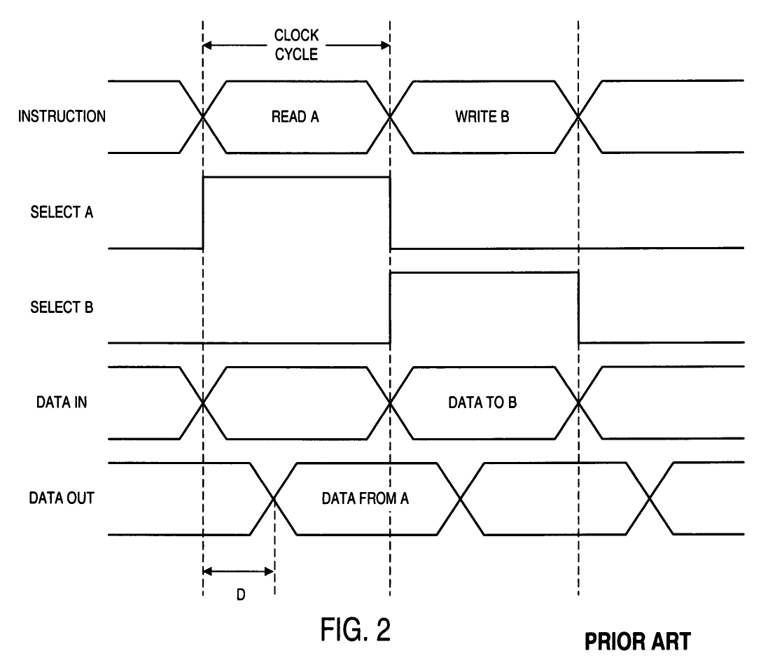

FIG. 3 is a flow chart of a method performed by a core processor according to some embodiments.

FIG. 4 is a timing diagram illustrating signals on a coprocessor bus according to some embodiments.

FIG. 5 is a flow chart of a method performed by a coprocessor according to some embodiments.

FIG. 6 is a block diagram of a system including a core processor and a number of coprocessors according to one embodiment.

FIG. 7 is a block diagram of an apparatus that facilitates an exchange of data between coprocessors according to some embodiments.

FIG. 8 is a block diagram of a network processor according to some embodiments.

### DETAILED DESCRIPTION

Some embodiments described herein are associated with “coprocessors.” As used herein, the term “coprocessor” can refer to any processor resource that facilitates the operation of a central or core processor. Moreover, the phrase “coprocessor bus” can refer to any set of paths that may be used to exchange information between a processor and a number of coprocessors (e.g., including instruction paths, data in paths, data out paths, and/or SELECT signal paths).

Coprocessor Bus Architecture

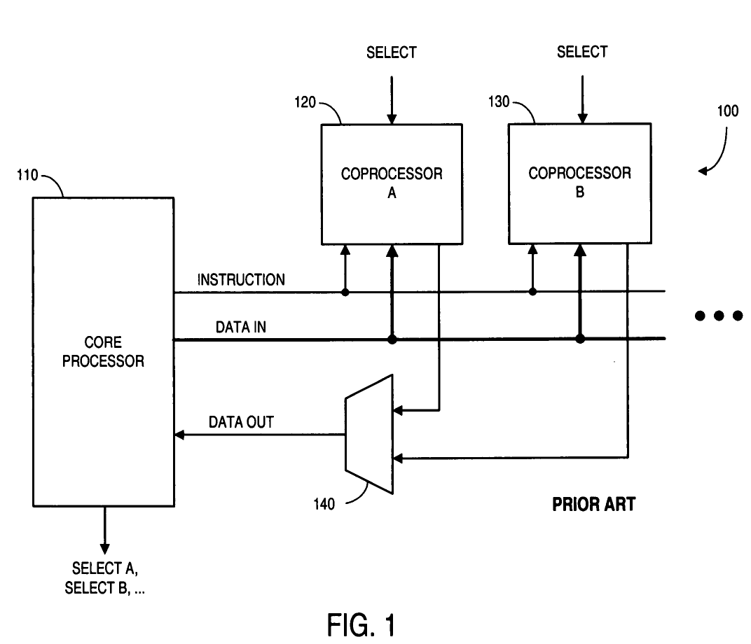

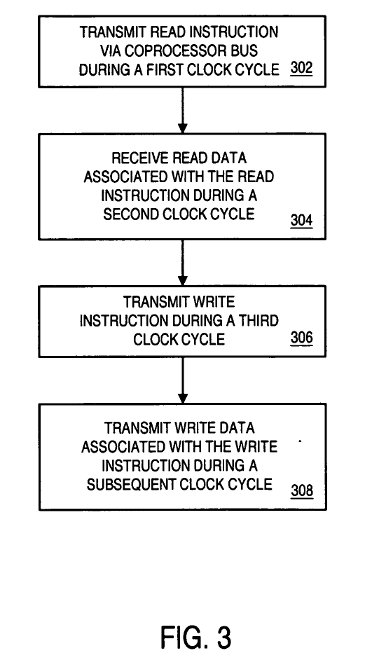

FIG. 3 is a flow chart of a method performed by a core processor according to some embodiments. The flow charts described herein do not necessarily imply a fixed order to the actions, and embodiments may be performed in any order that is practicable. The method of FIG. 3 might be associated with, for example, a system 100 similar to the one described with respect to FIG. 1. Note that any of the methods described herein may be performed by hardware, software (including microcode), or a combination of hardware and software. For example, a storage medium may store thereon instructions that when executed by a machine result in performance according to any of the embodiments described herein.

At 302, the core processor transmits to a coprocessor a read instruction via a coprocessor bus during a first clock cycle. At 304, the core processor receives from the coprocessor (via the coprocessor bus) read data associated with the read instruction during a second clock cycle subsequent to the first clock cycle.

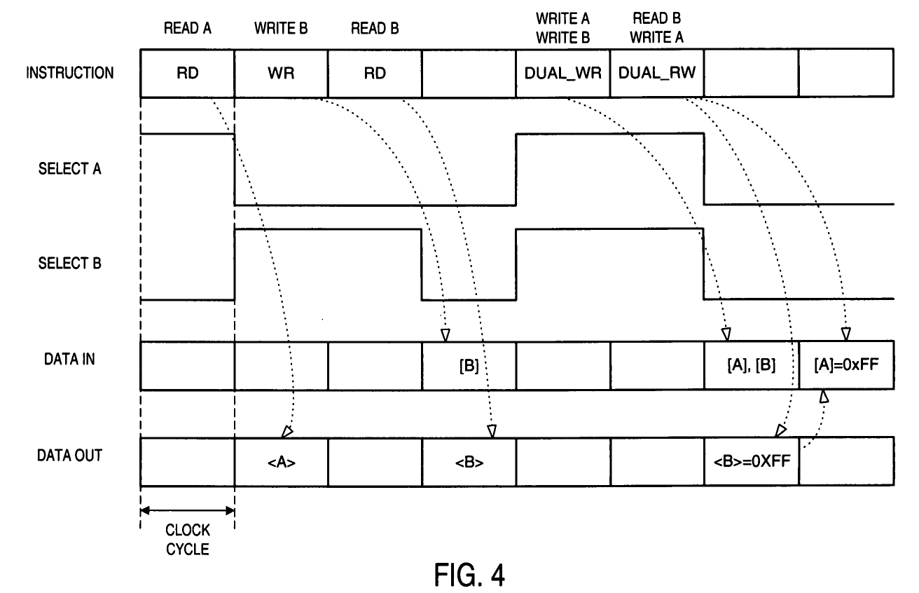

By way of example, FIG. 4 is a timing diagram illustrating signals on a coprocessor bus according to some embodiments. Here, the core processor places a read instruction (e.g., “RD”) and activates a SELECT A signal on the coprocessor bus during the first clock cycle. As a result, coprocessor A transmits the appropriate data (e.g., “<A>”) to the core processor during the next clock cycle. As used herein, information sent from a coprocessor to the core processor is represented as <X> while information sent from the core processor to a coprocessor is represented as [X].

Because the data is transmitted during a subsequent clock cycle, any delays introduced by the propagation of the RD instruction, the decoding of the RD instruction, the determination of <A>, and/or the propagation of <A> will not significantly restrict the speed of the coprocessor bus. Note that although <A> appears on the coprocessor bus during the clock cycle immediately following the RD instruction, according to other embodiments <A> might appear during an even later clock cycle.

Referring again to FIG. 3, at 306 the core processor transmits to a coprocessor a write instruction via the coprocessor bus during a third clock cycle. At 308, the core processor transmits to the coprocessor (via the coprocessor bus) write data associated with the write instruction during a subsequent clock cycle.

Consider again the timing diagram of FIG. 4. Here, the core processor places a write instruction (e.g., “WR”) and activates a SELECT B signal on the coprocessor bus during the third clock cycle. Moreover, the core processor transmits write data (e.g., “[B]”) via the coprocessor two clock cycles after the WR instruction. Note that although [B] appears on the coprocessor bus two clock cycles after the WR instruction, according to other embodiments [B] might appear during any clock cycle subsequent to the WR instruction.

When the core processor is to write data to a number of different coprocessors at substantially the same time, multiple SELECT signals can be activated on the coprocessor bus. For example, the core processor may place a dual write instruction (e.g., “DUAL_WR”) and activate both the SELECT A and the SELECT B signals on the coprocessor bus during a single clock cycle. The core processor may then transmit write data (e.g., “[A], [B]”) via the coprocessor bus two clock cycles after the DUAL_WR instruction. Both coprocessors will therefore receive the data that is present on the data in paths at substantially the same time.

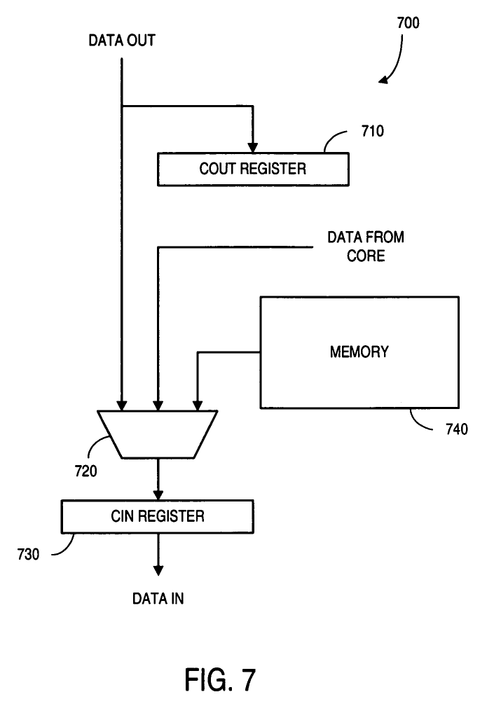

When the core processor is to transfer data from one coprocessor to another coprocessor, a transfer instruction may be used. For example, the core processor might want to transfer a value from coprocessor B to coprocessor A. In this case, the core processor can place a dual read-write instruction (e.g., “DUAL_RW”) and activate both the SELECT A and the SELECT B signals on the coprocessor bus. The core processor may then receive the appropriate value from coprocessor B during the next clock cycle (e.g., by selecting the B data out paths via a multiplexer to receive <B>=0xFF). Note that the value 0xFF is used only as an example. This information can then be placed on the data in paths during the next clock cycle to be received by coprocessor A. One apparatus that might be used to facilitate the transfer of 0xFF from the data out paths to the data in paths is described with respect to FIG. 7.

Note that according to the embodiment described with respect to FIGS. 3 and 4, certain sequences of consecutive access to a coprocessor might give unexpected results. According to some embodiments, an assembler program may prevent and/or flag such sequences to a programmer (e.g., so he or she will be aware that the results could be unexpected).

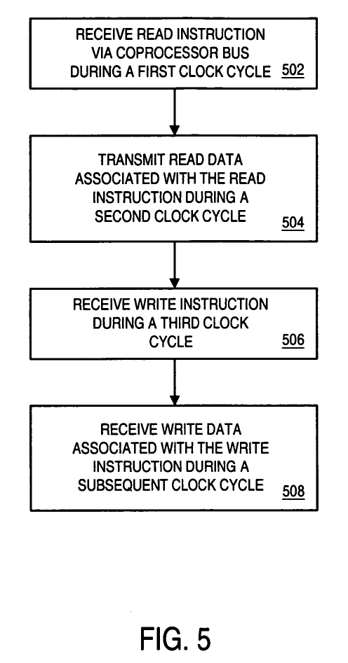

While FIG. 3 illustrated a method performed by a core processor, FIG. 5 is a flow chart of a method performed by a coprocessor according to some embodiments. At 502, the coprocessor receives from the core processor a read instruction via a coprocessor bus during a first clock cycle. At 504, the coprocessor transmits to the core processor (via the coprocessor bus) read data associated with the read instruction during a second clock cycle subsequent to the first clock cycle. At 506, the coprocessor receives from the core processor a write instruction via the coprocessor bus during a third clock cycle. At 508, the coprocessor receives from the core processor (via the coprocessor bus) write data associated with the write instruction during a subsequent clock cycle.

### EXAMPLE

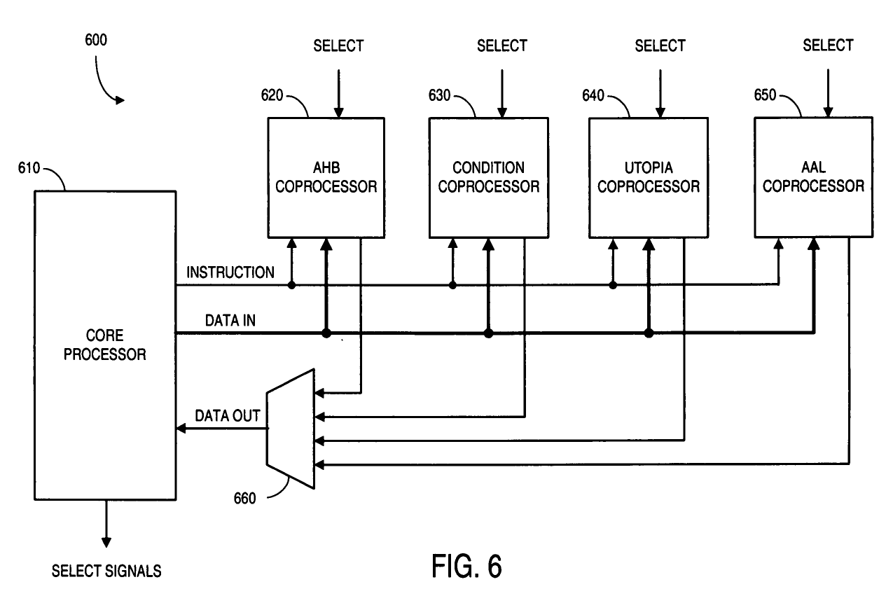

FIG. 6 is a block diagram of a system 600 including a core processor 610 according to one embodiment. The core processor 610 may, for example, act as a controller and linker to a variable number of coprocessors. According to this embodiment, the core processor 610 is a RISC microprocessor that performs low-level data PHY processing associated with Asynchronous Transfer Mode (ATM) information.

The system 600 also includes an Advanced High-Performance Bus (AHB) coprocessor 620 (e.g., to connect the core processor 610 to high-performance peripherals, memory controllers, and/or on-chip memory) and a condition coprocessor 630. Moreover, a Universal Test and Operations PHY Interface for ATM (UTOPIA) coprocessor 640 may facilitate operation in accordance with ATM Forum document AF-PHY-0017.000 entitled “UTOPIA Specification Level 1, Version 2.01” (March 1994). In addition, the system 600 includes an ATM Adaptation Layer coprocessor 650 to facilitate the segmentation of packets, the transmission of individual cells, and/or a reassembly process.

The core processor 610 communicates with the coprocessors via a coprocessor bus (e.g., including instruction paths, data in paths, data out paths, and SELECT signal paths) in accordance with any of the embodiments described herein. For example, the core processor 610 may place a read instruction on the coprocessor bus and activate the SELECT signal for the UTOPIA processor 640 during a first clock cycle. As a result, the UTOPIA coprocessor 640 will transmit the appropriate data via the data out paths during the next clock cycle.

As another example, the core processor 610 may place a write instruction on the coprocessor bus and activate a SELECT signal for the AAL coprocessor 650 during a first clock cycle. The core processor 610 will then transmit write data (via the data in paths) two clock cycles after the write instruction.

As still another example, the core processor 610 may place a dual write instruction on the coprocessor bus and activate SELECT signals for the AHB coprocessor 620 and the condition coprocessor 630 at substantially the same time. The core processor 610 may then transmit write data (via the data in paths) two clock cycles after the dual write instruction. Thus, both coprocessors 620, 630 can receive the data that is present on the data in paths at substantially the same time.

As yet another example, the core processor 610 may place a transfer instruction on the coprocessor bus and activate SELECT signals for both the UTOPIA coprocessor 640 and the AAL coprocessor 650. The core processor 610 may then receive an appropriate value from the UTOPIA coprocessor 640 during the next clock cycle (e.g., by selecting those data out paths via a multiplexer 660). This information is then placed on the data in paths during the next clock cycle to be received by the AAL coprocessor 650. One apparatus that might be used to facilitate this process will now be described with respect to FIG. 7.

Data Transfer Between Coprocessors

FIG. 7 is a block diagram of an apparatus 700 that facilitates an exchange of data between coprocessors. In particular, the data out paths from the coprocessor bus are provided to a COUT register 710 (e.g., to store data received from a coprocessor for timing reasons).

The data out paths are also provided to a multiplexer 720. The multiplexer 720 can then provide information from the data out paths to a CIN register 730 (e.g., to store data that will be sent to a coprocessor), which in turn passes the information to the data in paths of the coprocessor bus. In this way, a transfer of data from one coprocessor (e.g., via the data out paths) to another processor (e.g., via the data in paths) may be facilitated.

In addition to the data out paths, the multiplexer 720 may receive information from within the processor core and/or from a memory unit 740. The multiplexer 720 can then be used to select which information will be provided to the CIN register 730 (and ultimately to the data in paths of the coprocessor bus).

Note that the apparatus 700 may be located within a core processor. According to other embodiments, however, the apparatus 700 is located outside the core processor (e.g., for timing purposes).

Network Processor

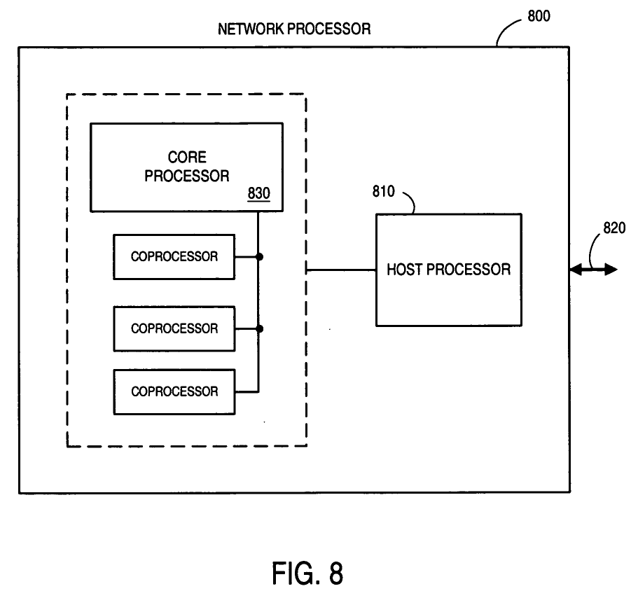

FIG. 8 is a block diagram of a network processor 800 according to some embodiments. The network processor 800 includes a host processor 810 to facilitate an exchange of information with at least one remote device (e.g., via an ATM switch fabric 820 that may include a UTOPIA interface). The network processor 800 also includes a subsystem having a core processor 830 and a number of coprocessors. The core processor 830 and coprocessors may communicate via a coprocessor bus in accordance with any of the embodiments described herein.

### Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although some embodiments have been described with respect to the ATM protocol, other embodiments may be associated with other protocols, including Internet Protocol (IP) packets exchanged in accordance with a System Packet Interface (SPI) as defined in ATM Forum document AF-PHY-0143.000 entitled “Frame-Based ATM Interface (Level 3)” (March 2000) or in Optical Internetworking Forum document OIF-SPI3-01.0 entitled “System Packet Interface Level 3 (SPI-3): OC-48 System Interface for Physical and Link Layer Devices” (June 2000). Moreover, Synchronous Optical Network (SONET) technology may be used to transport IP packets in accordance with the Packets Overt SONET (POS) communication standard as specified in the Internet Engineering Task Force (IETF) Request For Comment (RFC) 1662 entitled “Point to Point Protocol (PPP) in High-level Data Link Control (HDLC)-like Framing” (July 1994) and RFC 2615 entitled ” PPP over SONET/Synchronous Digital Hierarchy (SDH)” (June 1999).

The several embodiments described herein are solely for the purpose of illustration. Persons skilled in the art will recognize from this description other embodiments may be practiced with modifications and alterations limited only by the claims.

1. A method,comprising:
transmitting a write instruction via a coprocessor bus during a first clock cycle; and
transmitting write data associated with the write instruction via the coprocessor bus during a second clock cycle, the second clock cycle being after the first clock cycle.

2. The method of claim 1, wherein the second clock cycle is two clock cycles after the first clock cycle.

3. The method of claim 1, further comprising:
transmitting a read instruction via the coprocessor bus during a third clock cycle; and
receiving read data associated with the read instruction via the coprocessor bus during a fourth clock cycle, the fourth clock cycle being after the third clock cycle.

4. The method of claim 3, wherein the fourth clock cycle is one clock cycle after the third clock cycle.

5. The method of claim 1, wherein said transmitting comprises a core processor transmitting the information to a coprocessor.

6. The method of claim 1, wherein the write instruction is associated with a plurality of coprocessors.

7. A method, comprising:
receiving a write instruction via a coprocessor bus during a first clock cycle; and
receiving write data associated with the write instruction via the coprocessor bus during a second clock cycle, the second clock cycle being after the first clock cycle.

8. The method of claim 7, wherein said receiving comprises a coprocessor receiving the information from a core processor.

9. A method, comprising:
transmitting a read instruction via a coprocessor bus during a first clock cycle; and
receiving read data associated with the read instruction via the coprocessor bus during a second clock cycle, the second clock cycle being after the first clock cycle.

10. The method of claim 9, wherein said transmitting comprises transmitting the right instruction from a core processor to a coprocessor.

11. A method, comprising:
transmitting a transfer instruction via a coprocessor bus; and
facilitating an exchange of data associated with the transfer instruction from a first coprocessor to a second coprocessor.

12. The method of claim 11, wherein said facilitating is performed outside a host processor.

13. The method of claim 11, wherein said facilitating is performed within a host processor and comprises:
receiving the data from the first coprocessor during a clock cycle; and
transmitting the data to the second coprocessor during the following clock cycle.

14. An apparatus, comprising:
a core processor; and
a coprocessor bus,
wherein the core processor is to (i) transmit a write instruction via the coprocessor bus during a first clock cycle and (ii) transmit write data associated with the write instruction via the coprocessor bus during a second clock cycle, the second clock cycle being after the first clock cycle.

15. The apparatus of claim 14, wherein the second clock cycle is two clock cycles after the first clock cycle.

16. The apparatus of claim 14, wherein the core processor is further to (iii) transmit a read instruction via the coprocessor bus during a third clock cycle and (iv) receive read data associated with the read instruction via the coprocessor bus one clock cycle after the third clock cycle.

17. An apparatus, comprising:
a coprocessor; and
a coprocessor bus,
wherein the coprocessor is to (i) receive a write instruction via the coprocessor bus during a first clock cycle and (ii) receive write data associated with the write instruction via the coprocessor bus during a second clock cycle, the second clock cycle being after the first clock cycle.

18. The apparatus of claim 17, coprocessor is further to (iii) receive a read instruction via the coprocessor bus during a third clock cycle and (iv) transmit read data associated with the read instruction via the coprocessor bus during a fourth clock cycle, the fourth clock cycle being after the third clock cycle.

19. An apparatus, comprising:
a storage medium having stored thereon instructions that when executed by a machine result in the following:
transmitting a write instruction via a coprocessor bus during a first clock cycle; and
transmitting write data associated with the write instruction via the coprocessor bus during a second clock cycle, the second clock cycle being after the first clock cycle.

20. The apparatus of claim 19, wherein the instructions further result in the following:
transmitting a read instruction via the coprocessor bus during a third clock cycle; and
receiving read data associated with the read instruction via the coprocessor bus during a fourth clock cycle, the fourth clock cycle being after the third clock cycle.

21. An apparatus, comprising:
a storage medium having stored thereon instructions that when executed by a machine result in the following:
receiving a write instruction via a coprocessor bus during a first clock cycle; and
receiving write data associated with the write instruction via the coprocessor bus during a second clock cycle, the second clock cycle being after the first clock cycle.

22. The apparatus of claim 21, wherein the instructions further result in the following:
receiving a read instruction via the coprocessor bus during a third clock cycle; and
transmitting read data associated with the read instruction via the coprocessor bus during a fourth clock cycle, the fourth clock cycle being after the third clock cycle.

23. A system, comprising:
a UTOPIA interface;
a host processor to facilitate an exchange of information with at least one remote device via the switch fabric; and
a subsystem, comprising:
a core processor,
a plurality of coprocessors, and
a coprocessor bus connected to the core processor and the plurality of coprocessors,
wherein the core processor is to (i) transmit a write instruction via the coprocessor bus during a first clock cycle and (ii) transmit write data associated with the write instruction via the coprocessor bus during a second clock cycle, the second clock cycle being after the first clock cycle.

24. The system of claim 23, wherein the core processor is further to (iii) transmit a read instruction via the coprocessor bus during a third clock cycle and (iv) receive read data associated with the read instruction via the coprocessor bus during a fourth clock cycle, the fourth clock cycle being after the third clock cycle.
